(19) United States
(12) Patent Application Publication
(10) Pub. No.: US 2013/0025194 A1
(43) Pub. Date: Jan. 31, 2013

(54) Landscape edging system

(71) Applicant: Paul Adam, Jefferson City, MO (US)

(72) Inventor: Paul Adam, Jefferson City, MO (US)

(21) Appl. No.: 13/136,275

(22) Filed: Jul. 27, 2011

(51) Int. Cl. A01G 1/08

(52) U.S. Cl. 47/33

(57) ABSTRACT

A landscape edging system is disclosed in which the landscape edging system comprises a plurality of blocks for forming a edging with each of the blocks comprising a back face that is configured to be placed against a raised area, a bottom face for placement on the ground, an elevated top portion, a lower top portion, an elevated front face between the elevated top portion and the lower top portion, a lower side front face, a right elevated side face, a right lower side face having a tongue portion extending out from the right lower side face, a left elevated side face, a left lower side face having a groove portion formed in the left lower side face.

### BACKGROUND

This disclosure relates to a landscape edging system and more particularly to a landscape edging system that provides a low edge surface upon which a lawn mower may ride or travel when cutting grass and a high edge surface for retaining landscape elements such as mulch or rock. More specifically, a landscape edging system is disclosed having various shaped blocks that can be combined or placed contiguously to form a stable load-bearing guide surface for the wheels of a lawn mover in a multitude of patterns or configurations.

The landscaping of residential and commercial properties can include a lawn in combination with various other landscaping structures. For example, a grass lawn may encompass a majority of the landscaping with trees and a planting bed being interspersed in the grass lawn. In this case, a border may be formed between the grass lawn and the trees and the planting bed. The border may be constructed using various materials such as railroad ties, rocks, blocks, and plastic edging. Although such borders are decorative, they pose a problem when cutting the grass lawn. In particular, there is an edge between the grass lawn and the border which is difficult to cut by use of lawn mowing equipment and requires trimming of the edge so that the height of the grass in the edge is the same as the height of the grass in the lawn. Trimming is time consuming and requires additional equipment to trim the edge. Although there have been various edging systems proposed, such systems have disadvantages. For example, such systems are difficult for a homeowner to install and require a professional installation. A professional installation adds to the cost of the system. Also, some of the edging systems are expensive to manufacture which adds to the cost of installing the system. Another disadvantage is that the edging systems do not lock or hold the edging system in place. In view of this, such systems are subject to failure and need to be replaced or completely removed. Another disadvantage is that the edging systems do not allow for the construction of different shaped borders. In particular, only a few border configurations may be constructed. For example, some edging systems only provide for the installation of a rectangular shaped border. If a rounded border is desired then the edging system may not be used. Further, if an irregular shaped border, such as a kidney shaped border, is required then such edging systems are not capable of forming an irregular shaped border.

Therefore, it would be desirable to have a landscape edging system that is versatile and adapted to form any shape or configuration required in a landscaped area. It would also be advantageous to have a landscape edging system that locks in place and is easy to install by both professionals and homeowners. Moreover, the landscape edging system of the present disclosure can be employed to easily construct various complex landscaping configurations with a small number of blocks comprising the landscape edging system.

### BRIEF SUMMARY

In one form of the present disclosure, a landscape edging system comprises a plurality of blocks for forming a edging with each of the blocks comprising a back face that is configured to be placed against a raised area, a bottom face for placement on the ground, an elevated top portion, a lower top portion, an elevated front face between the elevated top portion and the lower top portion, a lower side front face, a right elevated side face, a right lower side face having a tongue portion extending out from the right lower side face, a left elevated side face, a left lower side face having a groove portion formed in the left lower side face.

In another form of the present disclosure, a landscape edging system is disclosed for forming a border surface along a multilevel landscape setting having a lawn area and a raised area, the lawn area having a ground surface having grass that is mowed and the raised area having a surface that is elevated above the ground surface of the lawn area, with the landscape edging system comprising a plurality of blocks for forming the border with each of the blocks comprising a back face that is configured to be placed against the raised area, a bottom face for placement in the ground, an elevated top portion, a lower top portion, an elevated front face between the elevated top portion and the lower top portion, a lower side front face, a right elevated side face, a right lower side face having a tongue portion extending out from the right lower side face and between the lower top portion and the bottom face, a left elevated side face, and a left lower side face having a groove portion formed in the left lower side face between the lower top portion and the bottom face

In yet another form of the present disclosure, a landscape edging system is disclosed for forming a border surface along a multilevel landscape setting having a lawn area and a raised area, the lawn area having a ground surface having grass that is mowed and the raised area having a surface that is elevated above the ground surface of the lawn area, the landscape edging system comprising a plurality of blocks for forming the border with each of the blocks comprising a back face that is configured to be placed against the raised area, a bottom face for placement in the ground, an elevated top portion, a lower top portion, an elevated front face between the elevated top portion and the lower top portion, a lower side front face, a right elevated side face, a right lower side face having a tongue portion extending out from the right lower side face and between the lower top portion and the bottom face and between the right elevated side face and the right lower side face, a left elevated side face, and a left lower side face having a groove portion formed in the left lower side face between the lower top portion and the bottom face and between the left elevated side face and the left lower side face.

The present disclosure also provides a landscape edging system that is easy to use to construct both residential and commercial landscaping projects.

The present disclosure provides a landscape edging system having blocks that are strong, not prone to breaking, and can withstand lawn mowing equipment being moved over the blocks.

The present disclosure provides a landscape edging system having blocks that are small, lightweight, easy to handle, and are prone to not shift or tilt once installed.

The present disclosure also provides a landscape edging system having a few blocks that can be installed in numerous layouts, designs, and patterns.

The present disclosure provides a landscape edging system in which the blocks can be manufactured by use of a mold having a raised area and a mold screed or strike-off plate used in conjunction with the mold having a raised area to form the various blocks of the landscape edging system.

The present disclosure also provides a landscape edging system having blocks in which the blocks are locked together to control separating and to allow a mower to ride on or over the blocks to control movement of the blocks.

These and other advantages of the present disclosure will become apparent after considering the following detailed specification in conjunction with the accompanying drawings, wherein:

### BRIEF DESCRIPTION OF THE DRAWINGS

FIG. 1 is a top view of the landscape edging system constructed according to the present disclosure being installed in a landscaped area;

FIG. 2 is a perspective view of a straight block of the landscape edging system constructed according to the present disclosure;

FIG. 3 is a top view of the straight block of the landscape edging system constructed according to the present disclosure;

FIG. 4 is a perspective view of an outside arc block of the landscape edging system constructed according to the present disclosure;

FIG. 5 is a top view of the outside arc block of the landscape edging system constructed according to the present disclosure;

FIG. 6 is a perspective view of an inside arc block of the landscape edging system constructed according to the present disclosure;

FIG. 7 is a top view of the inside arc block of the landscape edging system constructed according to the present disclosure;

FIG. 8 is a perspective view of an outside corner block of the landscape edging system constructed according to the present disclosure;

FIG. 9 is a top view of the outside corner block of the landscape edging system constructed according to the present disclosure;

FIG. 10 is a perspective view of an inside corner block of the landscape edging system constructed according to the present disclosure;

FIG. 11 is a top view of the inside corner block of the landscape edging system constructed according to the present disclosure;

FIG. 12 is a perspective view of an outside radius block of the landscape edging system constructed according to the present disclosure;

FIG. 13 is a top view of the outside radius block of the landscape edging system constructed according to the present disclosure;

FIG. 14 is a perspective view of an inside radius block of the landscape edging system constructed according to the present invention;

FIG. 15 is a top view of an inside radius block of the landscape edging system constructed according to the present invention;

FIG. 16 is an end view of the straight block of the landscape edging system being installed in the ground in a landscaped area;

FIG. 17 is a top view of a mold box used to manufacture blocks of the landscape edging system of the present disclosure;

FIG. 18 is a side view of the mold box and a screed plate used to manufacture blocks of the landscape edging system of the present disclosure; and

FIG. 19 is a is a top view of the landscape edging system constructed according to the present disclosure being installed around a tree.

### DETAILED DESCRIPTION OF PREFERRED EMBODIMENTS

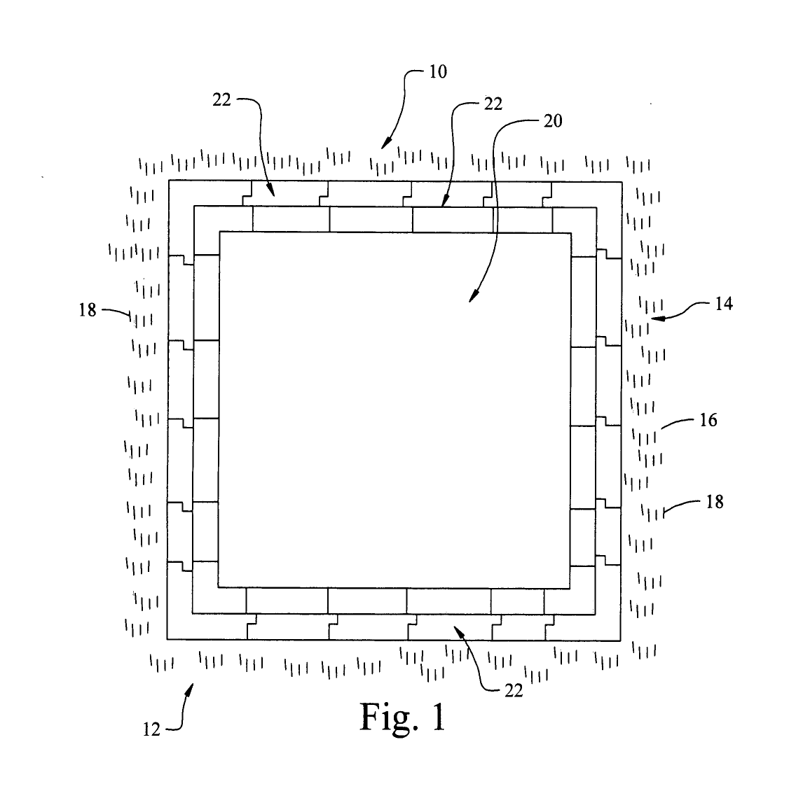

Referring now to the drawings, wherein like numbers refer to like items, number 10 identifies a landscape edging system constructed according to the present disclosure. With reference now to FIG. 1, the landscape edging system 10 is shown being installed in a multilevel landscaped setting 12. The multilevel landscaped setting 12 comprises a lawn area 14 having a ground surface 16 having grass 18 that may be mowed by a lawn mower (not shown), and a raised area 20 that is elevated above the ground surface 16. Although not shown in any detail, the raised area 20 may include many items such as rocks, mulch, trees, bushes, sculptures, a walkway, and any other item that a landscaper or homeowner may desire. As can be appreciated, the grass 18 grows up against the landscape edging system 10 and the landscape edging system 10 provides an edge, a platform, or a surface 22 upon which wheels of a lawn mower may travel or ride when cutting the grass 18. In this manner, the grass 18 abutting against the landscape edging system 10 does not need to be separately trimmed. The grass 18 may be cut in one pass of the lawn mower. The landscape edging system 10 forms a border between the raised area 20 and the lawn area 14.

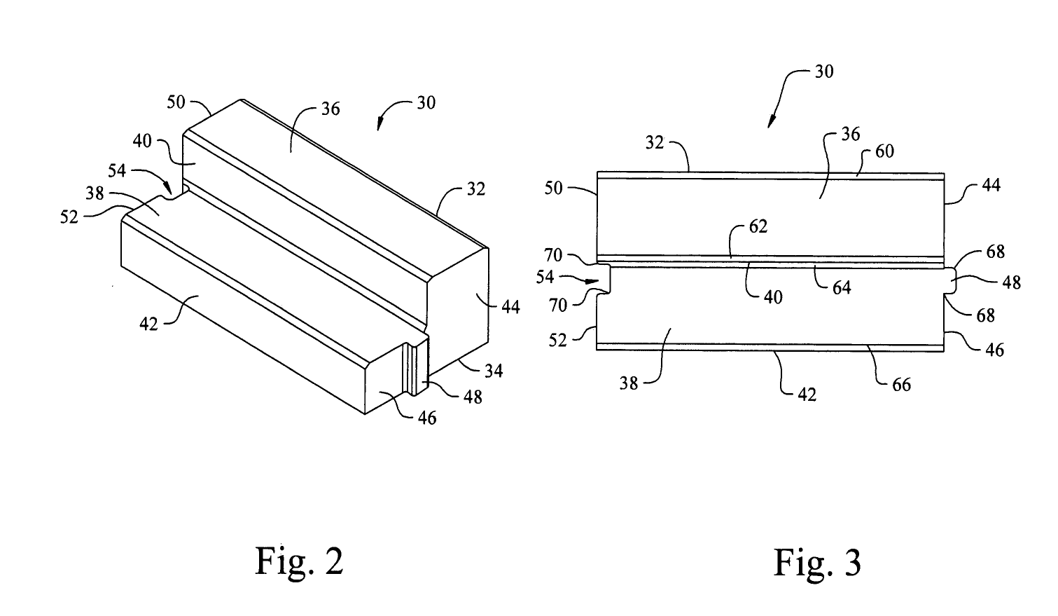

FIG. 2 is a perspective view of a straight block 30 used in the landscape edging system 10. The straight block 30 comprises a back face 32 that is configured to be placed against the raised area 20 and a bottom face 34 for placement in the ground, an elevated top portion 36, a lower top portion 38, an elevated front face 40 between the elevated top portion 36 and the lower top portion 38, a lower side front face 42, a right elevated side face 44, a right lower side face 46 having a tongue portion 48 extending out from the right lower side face 46, a left elevated side face 50, a left lower side face 52 having a groove portion 54 formed in the left lower side face 52. The tongue portion 48 extends between the bottom face 34 and the lower top portion 38. The lower top portion 38 serves as the edge 22 that lawn mowing equipment may ride upon when cutting grass 18. The faces 34, 40, 42, 44, 46, 50, 52 and the top portion 36 and the lower top portion 38 are generally planar and rectangular in shape.

Referring to FIG. 3, a top view of the straight block 30 is depicted. The straight block 30 is shown comprising the back face 32, the elevated top portion 36, the lower top portion 38, and the elevated front face 40 between the elevated top portion 36 and the lower top portion 38. The block 30 further comprises the lower side front face 42, the right elevated side face 44, the right lower side face 46 having the tongue portion 48 extending out from the right lower side face 46, and the left elevated side face 50. The left lower side face 52 has the groove portion 54 formed therein and also is formed in the lower top portion 38. The tongue portion 48 extends between the bottom face 34, which is not shown in this particular view, and the lower top portion 38. The lower top portion 38 serves as the platform or edge 22 upon which lawn mowing equipment may ride upon when cutting grass 18.

An eased, beveled, or rounded edge 60 is formed between back face 32 and the elevated top portion 36. Another eased or rounded edge 62 is formed between the elevated top portion 36 and the elevated front face 40. Between the elevated front face 40 and the lower top portion 38 is formed a rounded edge 64. Also, another eased or rounded edge 66 is formed between the lower top portion 38 and the lower side front face 42. The edges 60, 62, 64, and 66 are eased, beveled, or rounded to prevent the straight block 30 from being broken or chipped during manufacturing, transportation, storage, installation, or handling. Also, the tongue portion 48 may have rounded edges 68 and the groove portion 54 may have rounded edges 70. As can be appreciated, when a line of straight blocks 30 are placed side by side, the tongue portion 48 of one of the blocks 30 may be inserted into the groove portion 54 of the adjacent block 30. In this manner, the blocks 30 may be joined or mated together, as will be explained in more detail further herein.

For purposes of example only, some possible standard dimensions for the straight block 30 are as follows. The straight block 30 may be four inches tall at the back face 32, two inches tall at the lower side front face 42, six inches deep along the bottom face 34, and twelve inches wide along both the back face 32 and the lower side front face 42. The tongue portion 48 may extend out 7/16 inches, have a width of ⅞ inches, and have a height of two inches. The groove portion 54 may have a depth of ½ inches, a width of one inch, and a height of two inches. In this manner, the tongue portion 48 will fit within the groove portion 54. Another reason that the tongue portion 48 has a width of ⅞ inches and the groove portion 54 has a width of one inch is due to the manufacturing process. When manufacturing or molding the block 30, as will be described in more detail herein, a mold in which the block 30 is formed will wear down over time. In order to allow a mold to be used for as long as possible, these tolerances are built in to the block 30. It should be apparent that the tongue portion 48 and the groove portion 54 are positioned along the right lower side face 46 and the left lower side face 52, respectively. In this configuration, the tongue portion 48 and the groove portion 54 are not part of either the right elevated side face 44 or the left elevated side face 50. Further, by having the tongue portion 48 and the groove portion 54 positioned along the side faces 46 and 52, respectively, the connection between a pair of blocks 30 is strengthen and this helps prevent movement of the blocks 30 when lawn mowing or cutting equipment is placed on the lower top portion 38. Other reasons for positioning the tongue portion 48 on the side face 46 and the groove portion 54 on the side face 52 are that such a construction is easier to manufacture, it does not detract from the appearance of the block 30, and it prevents separation of the blocks 30 on an uneven surface such as a slight inclined or uphill surface.

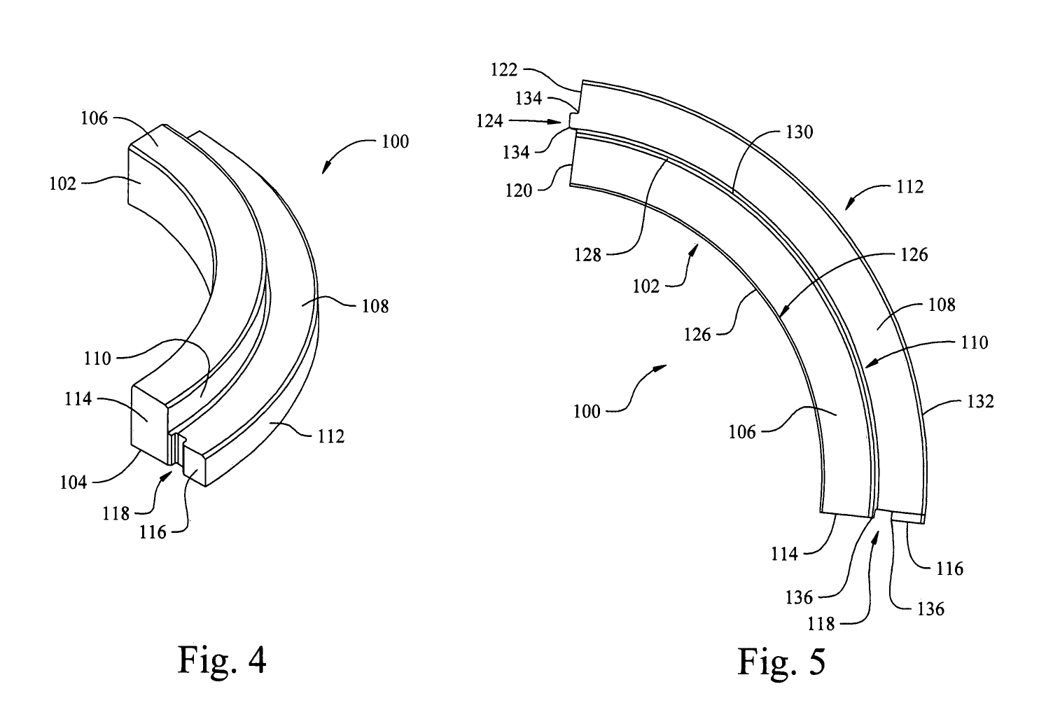

FIG. 4 is a perspective view of an outside arc block 100 employed in the landscape edging system 10. The outside arc block 100 is shown comprising a back face 102 that is configured to be placed against the raised area 20 and a bottom face 104 for placement in the ground, an elevated top portion 106, a lower top portion 108, an elevated front face 110 between the elevated top portion 106 and the lower top portion 108, a lower side front face 112, a left elevated side face 114, a left lower side face 116 having a groove portion 118 formed in the left lower side face 116. The lower top portion 108 serves as the edge 22 that lawn mowing equipment may ride upon when cutting grass 18.

With reference now to FIG. 5, a top perspective view of the outside arc block 100 is illustrated. The outside arc block 100 comprises a right elevated side face 120 and a right lower side face 122 having a tongue portion 124 extending out from the right lower side face 122. The tongue portion 124 extends between the bottom face 104, which is not shown in this particular view, and the lower top portion 108. The outside arc block 100 is also shown to comprise the back face 102, the elevated top portion 106, the lower top portion 108, the elevated front face 110, and the lower side front face 112. The left lower side face 116 has the groove portion 118 formed and the groove portion 118 is adapted for receiving a tongue portion 124 of an adjoining block 30 or 100. The groove portion 118 is formed in the left lower side face 116, the lower top portion 108, and the bottom face 104. The left elevated side face 114 is also illustrated.

An eased, beveled, or rounded edge 126 is formed between back face 102 and the elevated top portion 106. Another eased or rounded edge 128 is formed between the elevated top portion 106 and the elevated front face 110. Between the elevated front face 110 and the lower top portion 108 is formed a rounded edge 130. Also, another eased or rounded edge 132 is formed between the lower top portion 108 and the lower side front face 112. The edges 126, 128, 130, and 132 are eased, beveled, or rounded to prevent the block 100 from being broken or chipped during manufacturing, transportation, storage, installation, or handling. Also, the tongue portion 124 may have rounded edges 134 and the groove portion 118 may have rounded edges 136. As can be appreciated, when a circular border of outside arc blocks 100 are placed side by side, the tongue portion 124 of one of the blocks 100 may be inserted into the groove portion 118 of the adjacent block 100. In this manner, the blocks 100 may be joined or mated together. The blocks 100 are arcuate in configuration and have a radius of 90°. Due to this configuration, four of the blocks 100 may be used to form a circle. For example, the outside arc blocks 100 may be used to form a circular border around a tree.

Again, for purposes of example only, some possible standard dimensions for the outside arc block 100 are a height of four inches at the back face 102, two inches tall at the lower side front face 112, and six inches deep along the bottom face 104. The tongue portion 124 may extend out 7/16 inches, have a width of ⅞ inches, and have a height of two inches. The groove portion 118 may have a depth of ½ inches, a width of one inch, and a height of two inches. In this manner, the tongue portion 124 will fit within the groove portion 118. It should be apparent that the tongue portion 124 and the groove portion 118 are positioned along the right lower side face 122 and the left lower side face 116, respectively. In this configuration, the tongue portion 124 and the groove portion 118 are not part of either the right elevated side face 120 or the left elevated side face 114.

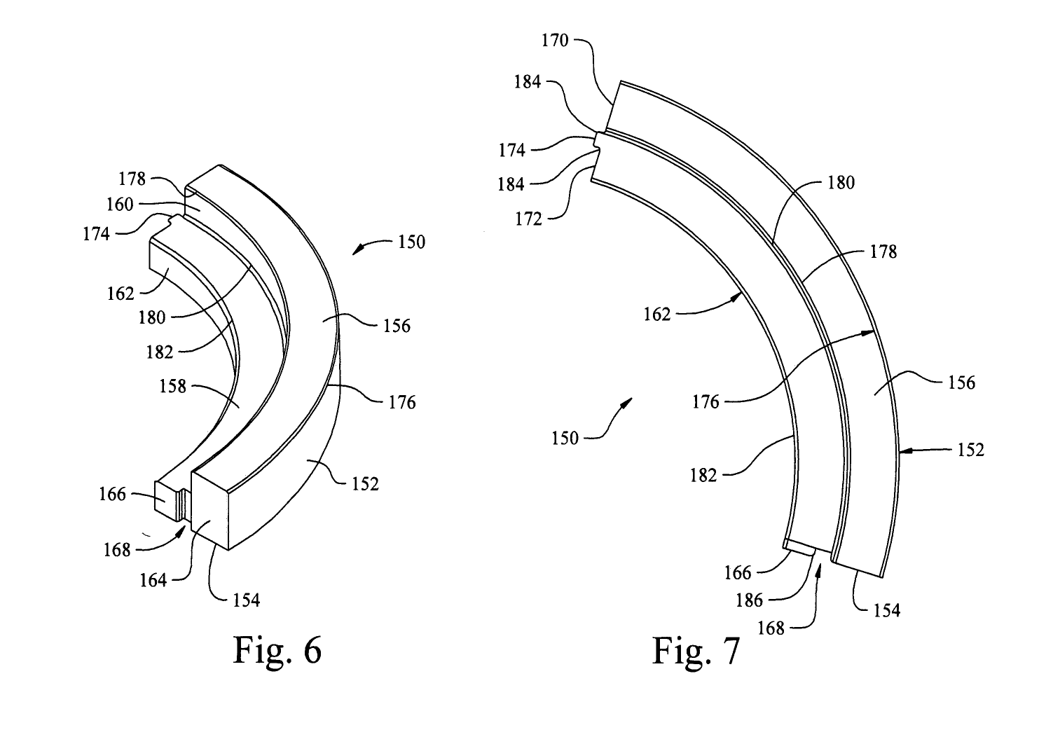

Referring now to FIG. 6, a perspective view of an inside arc block 150 is shown. The inside arc block 150 comprises a back face 152 that is configured to be placed against the raised area 20 and a bottom face 154 for placement in the ground, an elevated top portion 156, a lower top portion 158, an elevated front face 160 between the elevated top portion 156 and the lower top portion 158, a lower side front face 162, a left elevated side face 164, a left lower side face 166 having a groove portion 168 formed in the left lower side face 166. The lower top portion 158 serves as the edge 22 that lawn mowing equipment may ride upon when cutting the grass 18.

FIG. 7 depicts a top perspective view of the inside arc block 150. The inside arc block 150 further comprises a right elevated side face 170 and a right lower side face 172 having a tongue portion 174 extending out from the right lower side face 172. The tongue portion 174 extends between the bottom face 154, which is not shown in this particular view, and the lower top portion 158. The inside arc block 150 is also shown to comprise the back face 152, the elevated top portion 156, the lower top portion 158, the elevated front face 160, and the lower side front face 162. The left lower side face 166 has the groove portion 168 formed and the groove portion 168 is adapted for receiving a tongue portion 174 of an adjoining block 30 or 150. The groove portion 168 is formed in the left lower side face 166, the lower top portion 158, and the bottom face 154.

With reference now to both FIGS. 6 and 7, an eased, beveled, or rounded edge 176 is formed between back face 152 and the elevated top portion 156. Another eased or rounded edge 178 is formed between the elevated top portion 156 and the elevated front face 160. Between the elevated front face 160 and the lower top portion 158 is formed a rounded edge 180. Also, another eased or rounded edge 182 is formed between the lower top portion 158 and the lower side front face 162. The edges 176, 178, 180, and 182 are eased, beveled, or rounded to prevent the block 150 from being broken or chipped during manufacturing, transportation, storage, installation, or handling. Also, the tongue portion 174 may have rounded edges 184 and the groove portion 168 may have rounded edges 186. The blocks 150 are arcuate in shape and have a radius of 90°. As can be appreciated, when a circular border of inside arc blocks 150 are placed side by side, the tongue portion 174 of one of the blocks 150 may be inserted into the groove portion 168 of the adjacent block 150. In this manner, the blocks 150 may be joined or mated together.

Some possible standard dimensions for the inside arc block 150 are a height of four inches at the back face 152, two inches tall at the lower side front face 162, and six inches deep along the bottom face 154. The tongue portion 174 may extend out 7/16 inches, have a width of ⅞ inches, and have a height of two inches. The groove portion 168 may have a depth of ½ inches, a width of one inch, and a height of two inches. In this manner, the tongue portion 174 will fit within the groove portion 168. It should be apparent that the tongue portion 174 and the groove portion 168 are positioned along the right lower side face 172 and the left lower side face 166, respectively. In this configuration, the tongue portion 174 and the groove portion 168 are not part of either the right elevated side face 170 or the left elevated side face 164. The above listed dimensions are only for purposes of example. As can be appreciated, different dimensions may be used.

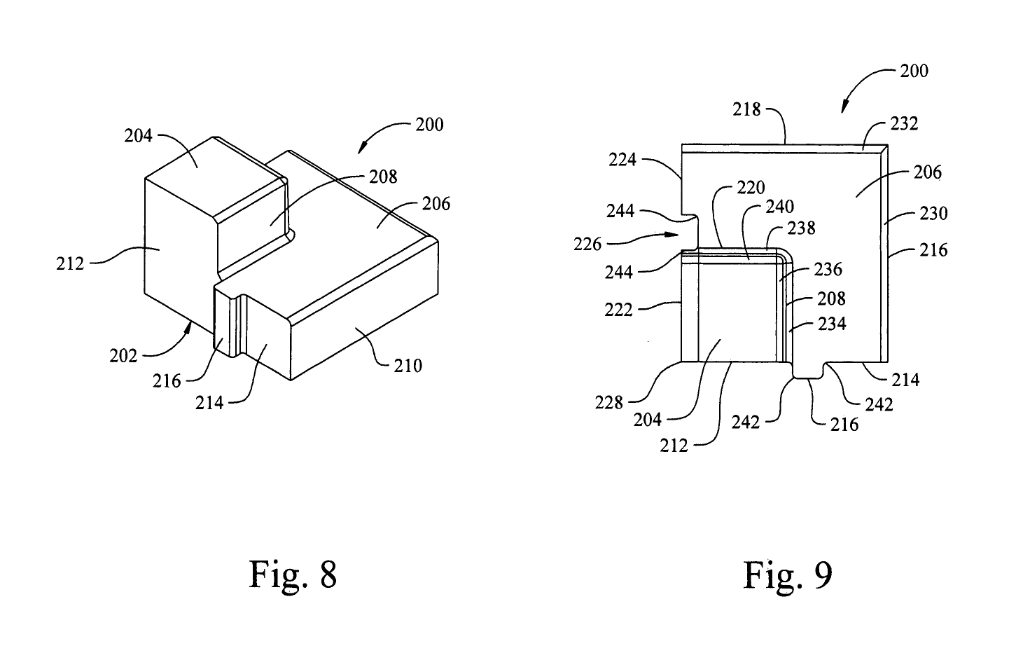

FIG. 8 is a perspective view of an outside corner block 200 that may be part of the landscape edging system 10. The outside corner block 200 comprises a bottom face 202 for placement in the ground, an elevated top portion 204, a lower top portion 206, an elevated left front face 208 between the elevated top portion 204 and the lower top portion 206, a left lower side front face 210, a left elevated side face 212, a left lower side face 214 having a tongue portion 216 extending out from the left lower side face 214. The tongue portion 216 extends between the bottom face 202 and the lower top portion 206. The lower top portion 206 serves as the platform or edge 22 that lawn mowing equipment may ride upon when cutting the grass 18.

With reference now to FIG. 9, a top perspective view of the outside corner block 200 is shown. In this particular view the outside corner block 200 is shown to further comprise a right lower side front face 218, an elevated right front face 220, a right elevated side face 222, a right lower side face 224, and a groove portion 226 formed in the right lower side face 224. The left elevated side face 212 and the right elevated side edge 222 intersect at an edge 228 which is configured to be placed against the raised area 20.

An eased, beveled, or rounded edge 230 is formed between the lower top portion 206 and the left lower side front face 210. Between the lower top portion 206 and the right lower side front face 218 another rounded edge 232 is formed. Another rounded edge 234 is provided between the lower top portion 206 and the elevated left front face 208. Between the elevated top portion 204 and the left front face 208 is formed another rounded edge 236. A further rounded edge 238 is provided between the lower top portion 206 and the elevated right front face 220. A rounded edge 240 is also formed between the elevated top portion 204 and the elevated right front face 220. The edges 230, 232, 234, 236, 238, and 240 are eased, beveled, or rounded to prevent the block 200 from being broken or chipped during manufacturing, transportation, storage, installation, or handling. Also, the tongue portion 216 may have rounded edges 242 and the groove portion 226 may have rounded edges 244. As can be appreciated, when an outside right angle border is required the outside corner block 200 is used. The tongue 48 of the straight block 30 may be inserted into the groove portion 226 of the outside corner block 200. The tongue portion 216 of the outside corner block 200 may be inserted into the groove portion 54 of the straight block 30. In this manner, the blocks 30 and 200 may be joined or mated together to form an outside corner for a border of the landscape edging system 10.

Some possible standard dimensions for the outside corner block 200 are a height of four inches at the left elevated side face 212 and the right elevated side face 222, two inches tall at the left lower side front face 210 and the right lower side front face 218, and the bottom face 202 being six inches square. The tongue portion 216 may extend out 7/16 inches, have a width of ⅞ inches, and have a height of two inches. The groove portion 226 may have a depth of ½ inches, a width of one inch, and a height of two inches. In this manner, the tongue portion 216 will fit within the groove portion 226. It should be apparent that the tongue portion 216 and the groove portion 226 are positioned along the left lower side face 214 and the right lower side face 224, respectively. In this configuration, the tongue portion 216 and the groove portion 226 are not part of either the left elevated side face 212 or the right elevated side face 222. Different dimensions may be used depending on the application and the above listed dimensions are only for purposes of example.

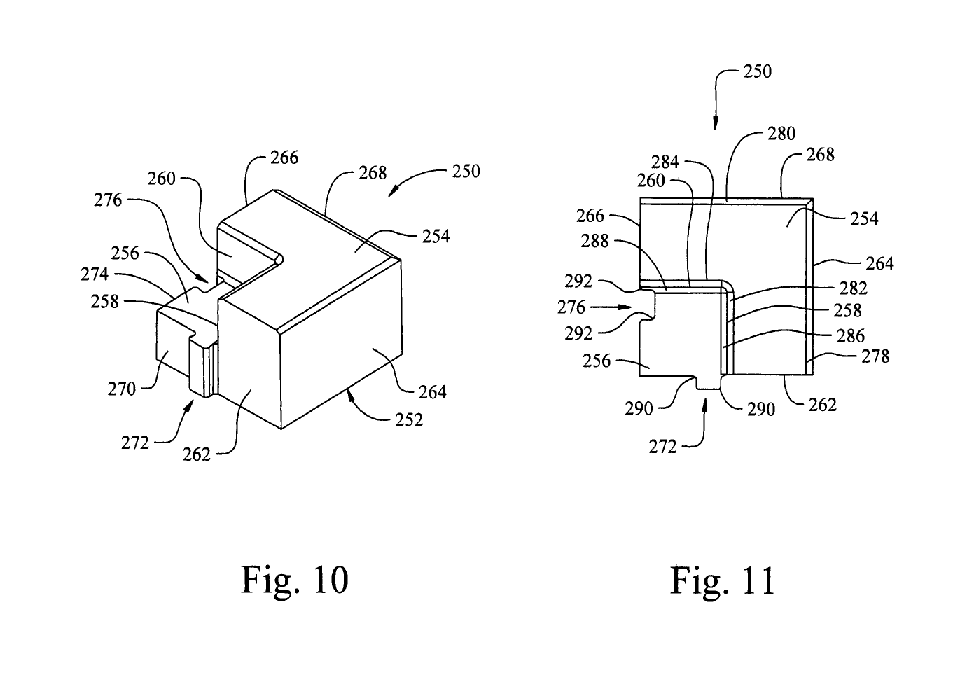

With reference now to FIG. 10, a perspective view of an inside corner block 250 is depicted. The inside corner block 250 comprises a bottom face 252 for placement in the ground, an elevated top portion 254, a lower top portion 256, an elevated left front face 258 between the elevated top portion 254 and the lower top portion 256, and an elevated right front face 260 between the elevated top portion 254 and the lower top portion 256. The block 250 further comprises a left elevated side face 262, a left back face 264, a right elevated side face 266, and a right back face 268. The left back face 264 and the right back face 268 are configured to be placed against the raised area 20. The block 250 also comprises a left lower side face 270 having a tongue portion 272 extending out from the left lower side face 270 and a right lower side face 274 having a groove portion 276 formed therein. The tongue portion 272 extends between the bottom face 252 and the lower top portion 256. The lower top portion 256 serves as the platform or edge 22 that lawn mowing equipment may ride upon when cutting the grass 18. The groove portion 276 extends between the bottom face 252 and the lower top portion 256.

FIG. 11 shows a top perspective view of the inside corner block 250. The inside corner block 250 also comprises an eased, beveled, or rounded edge 278 is formed between the top portion 254 and the left back face 264. Between the top portion 254 and the right back face 268 another rounded edge 280 is formed. Another rounded edge 282 is provided between the top portion 254 and the elevated left front face 258. Between the top portion 254 and the elevated right front face 260 is formed another rounded edge 284. A further rounded edge 286 is provided between the lower top portion 256 and the elevated left front face 258. A rounded edge 288 is also formed between the lower top portion 256 and the elevated right front face 260. The edges 278, 280, 282, 284, 286, and 288 are eased, beveled, angled, or rounded to prevent the block 250 from being broken or chipped during manufacturing, transportation, storage, installation, or handling. Also, the tongue portion 272 may have rounded edges 290 and the groove portion 276 may have rounded edges 292. As can be appreciated, when an inside right angle border is required the inside corner block 250 may be used. The tongue 48 of the straight block 30 may be inserted into the groove portion 276 of the inside corner block 250. The tongue portion 272 of the inside corner block 250 may be inserted into the groove portion 54 of the straight block 30. In this manner, the blocks 30 and 250 may be joined or mated together to form an inside corner for a border of the landscape edging system 10.

By way of example only, some possible standard dimensions for the inside corner block 250 are a height of four inches, two inches tall at the left lower side face 270 and the right lower side face 274, and the bottom face 252 being a six inch by six inch square. The tongue portion 272 may extend out 7/16 inches, have a width of ⅞ inches, and have a height of two inches. The groove portion 276 may have a depth of ½ inches, a width of one inch, and a height of two inches. In this manner, the tongue portion 272 will fit within the groove portion 276. It should be apparent that the tongue portion 272 and the groove portion 276 are positioned along the left lower side face 270 and the right lower side face 274, respectively. In this configuration, the tongue portion 272 and the groove portion 276 are not part of either the left elevated side face 262 or the right elevated side face 266.

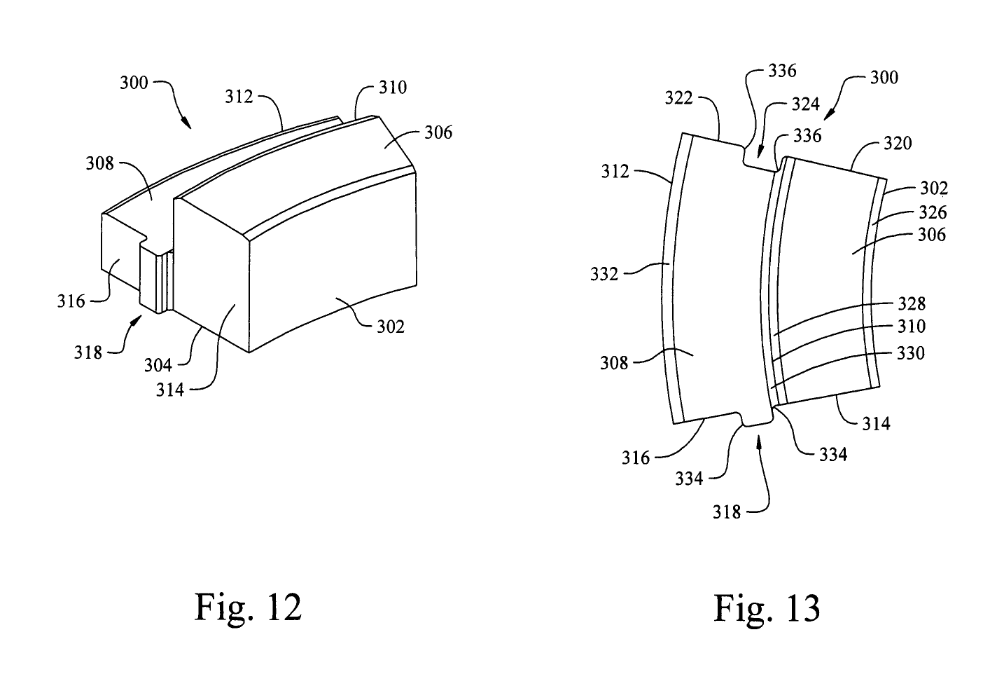

FIG. 12 illustrates a perspective view of an outside radius block 300 constructed according to the present disclosure. The outside radius block 300 comprises a back face 302 that is configured to be placed against the raised area 20 and a bottom face 304 for placement in the ground, an elevated top portion 306, a lower top portion 308, an elevated front face 310 positioned between the elevated top portion 306 and the lower top portion 308, a lower side front face 312, a left elevated side face 314, a left lower side face 316 having a groove portion 318 formed in the left lower side face 316. The lower top portion 308 serves as the edge 22 that lawn mowing equipment may ride upon when cutting grass 18.

With reference now to FIG. 13, a top perspective view of the outside radius block 300 is illustrated. The outside radius block 300 further comprises a right elevated side face 320 and a right lower side face 322 having a groove portion 324 formed in the right lower side face 322. The groove portion 324 extends between the bottom face 304, which is not shown in this particular view, and the lower top portion 308. The outside radius block 300 is also shown to comprise the back face 302, the elevated top portion 306, the lower top portion 308, the elevated front face 310, and the lower side front face 312. The left lower side face 316 has the tongue portion 318 extending out from the left lower side face 316. The tongue portion 318 is adapted to be placed or positioned in the groove portion 324 of an adjoining block 30 or 300.

An eased, beveled, or rounded edge 326 is formed between back face 302 and the elevated top portion 306. Another eased or rounded edge 328 is formed between the elevated top portion 306 and the elevated front face 310. Between the elevated front face 310 and the lower top portion 308 is formed a rounded edge 330. Also, another eased or rounded edge 332 is formed between the lower top portion 308 and the lower side front face 312. The edges 326, 328, 330, and 332 are eased, beveled, or rounded to prevent the block 300 from being broken or chipped during manufacturing, transportation, storage, installation, or handling. Also, the tongue portion 318 may have rounded edges 334 and the groove portion 324 may have rounded edges 336. As can be appreciated, when a outside radius circular border is required, the outside radius block 300 may be used. Each of the blocks 300 is arcuate in shape and has a radius of 22.5°. A total of sixteen of the blocks 300 may be used to form a complete circle. Also, the tongue portion 48 of the straight block 30 may be inserted into the groove portion 324 of the block 300 to form an outside radius border.

Again, for purposes of example only, some possible standard dimensions for the outside radius block 300 are a height of four inches at the back face 302, two inches tall at the lower side front face 312, and six inches deep along the bottom face 304. The tongue portion 318 may extend out 7/16 inches, have a width of ⅞ inches, and have a height of two inches. The groove portion 324 may have a depth of ½ inches, a width of one inch, and a height of two inches. In this manner, the tongue portion 318 will fit within the groove portion 324. It should be apparent that the tongue portion 318 and the groove portion 324 are positioned along the left lower side face 316 and the right lower side face 322, respectively.

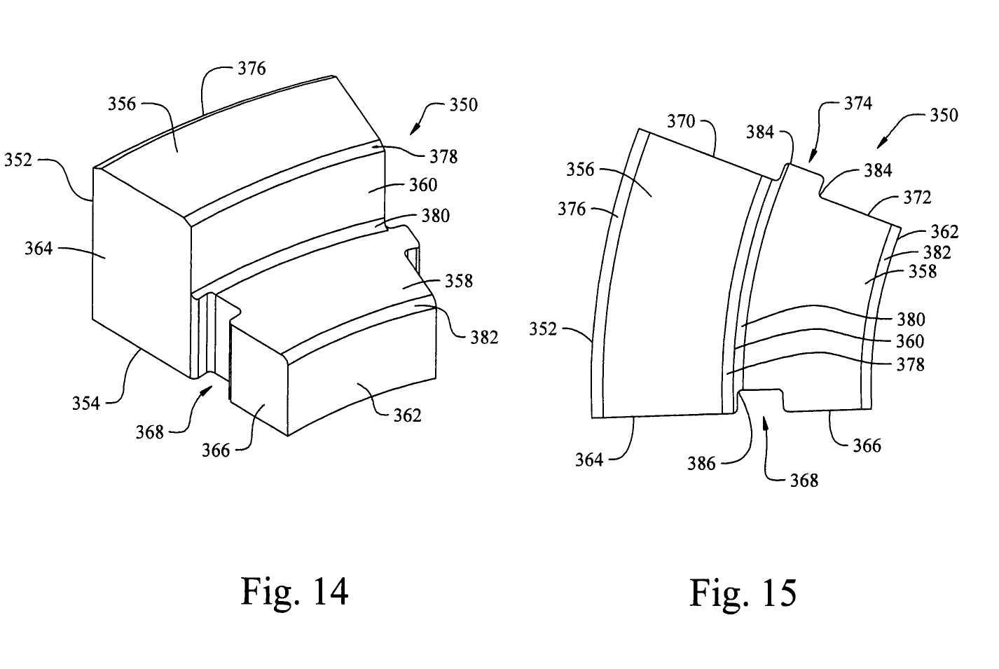

Referring now to FIG. 14, an inside radius block 350 is shown. The inside radius block 350 comprises a back face 352 that is configured to be placed against the raised area 20 and a bottom face 354 for placement in the ground, an elevated top portion 356, a lower top portion 358, an elevated front face 360 between the elevated top portion 356 and the lower top portion 358, a lower side front face 362, a left elevated side face 364, a left lower side face 366 having a groove portion 368 formed in the left lower side face 366. The lower top portion 358 serves as the edge 22 that lawn mowing equipment may travel or ride upon when cutting the grass 18.

FIG. 15 illustrates a top perspective view of the inside radius block 350. The inside radius block 350 further comprises a right elevated side face 370 and a right lower side face 372 having a tongue portion 374 extending out from the right lower side face 372. The tongue portion 374 extends between the bottom face 354, which is not shown in this particular view, and the lower top portion 358. The inside radius block 350 is also shown to comprise the back face 352, the elevated top portion 356, the lower top portion 358, the elevated front face 360, and the lower side front face 362. The left lower side face 366 has the groove portion 368 formed and the groove portion 368 is adapted for receiving a tongue portion 374 of an adjoining block 30 or 350. The groove portion 368 is formed in the left lower side face 366, the lower top portion 358, and the bottom face 354. As can be appreciated, the inside radius block 350 is used to form a border when an inside radius is required. Further, each of the blocks 350 is arcuate in configuration and has a radius of 22.5°. Due to this construction, a total of sixteen of the blocks 350 may be used to form a complete circular border.

With reference now to both FIGS. 14 and 15, an eased, beveled, or rounded edge 376 is formed between back face 352 and the elevated top portion 356. Another eased or rounded edge 378 is formed between the elevated top portion 356 and the elevated front face 360. Between the elevated front face 360 and the lower top portion 358 is formed a rounded edge 380. Also, another eased or rounded edge 382 is formed between the lower top portion 358 and the lower side front face 362. The edges 376, 378, 380, and 382 are eased, beveled, or rounded to prevent the block 350 from being broken or chipped during manufacturing, transportation, storage, installation, or handling. Also, the tongue portion 374 may have rounded edges 384 and the groove portion 368 may have rounded edges 386.

As has been referenced previously, the block 350 may be formed in sizes that are standardized. Some possible standard dimensions for the inside radius block 350 are a height of four inches at the back face 352, two inches tall at the lower side front face 362, and six inches deep along the bottom face 354. The tongue portion 374 may extend out 7/16 inches, have a width of ⅞ inches, and have a height of two inches. The groove portion 368 may have a depth of ½ inches, a width of one inch, and a height of two inches. In this manner, the tongue portion 374 will fit within the groove portion 368. It should be apparent that the tongue portion 374 and the groove portion 368 are positioned along the right lower side face 372 and the left lower side face 366, respectively. In this configuration, the tongue portion 374 and the groove portion 368 are not part of either the right elevated side face 370 or the left elevated side face 364.

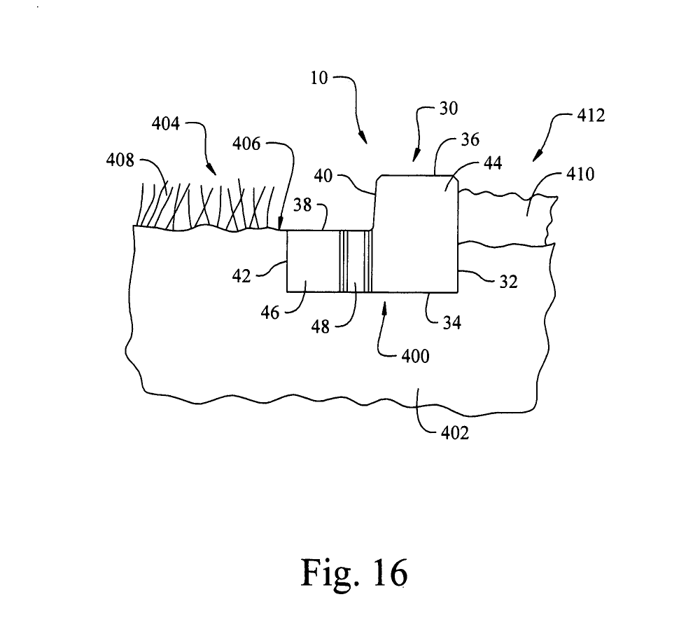

As depicted in FIG. 16, a straight block 30 is shown being installed in a dugout or trench area 400 of soil 402 in the ground 404. The trench area 400 may be excavated which approximates the size of the block 30 and the desired border configuration. The trench area 400 is dug deep enough so that the lower top portion 38 of the straight block 30 is level with a ground level 406 of the ground 404. Although not shown, it is also possible to provide a leveling base, such as crushed rock, on the soil 402 to place the bottom face 34 of the block 30. The ground level 406 has grass 408 on a side in which the top portion 38 is presented to allow a lawn mower (not shown) to ride or travel over when cutting the grass 408. The back side 32 of the block 30 is shown abutting up against mulch 410 that is in a landscaped area 412. In this manner, the block 30 is able to keep the mulch 410 within the landscaped area 412 and also to provide the lower top portion 38 as a surface upon which the lawn mower may move or travel. The lower top portion 38 allows the grass 408 to be cut without having to go back and trim the area between the grass 408 and the mulch 410 if the landscape edging system 10 had not been installed. Again, since the lower top portion 38 is level or flush with the ground level 406, a lawn mower may ride continuously along the lower top portion 38 of the block 30 when cutting the grass 408. Once the block 30 is installed, another block 30 may have its groove portion 54 placed over the tongue portion 48 to lock the two blocks 30 together. Further, due to the standardization of the tongue portions and groove portions of the blocks 30, 100, 150, 200, 250, 300, and 350 described herein, any of the blocks may be connected together to form any shape and sized border configuration. Also, although the block 30 is depicted as being installed in the trench area 400, it is also possible and contemplated to install any of the other blocks 100, 150, 200, 250, 300, and 350, as have been described herein, in the same manner.

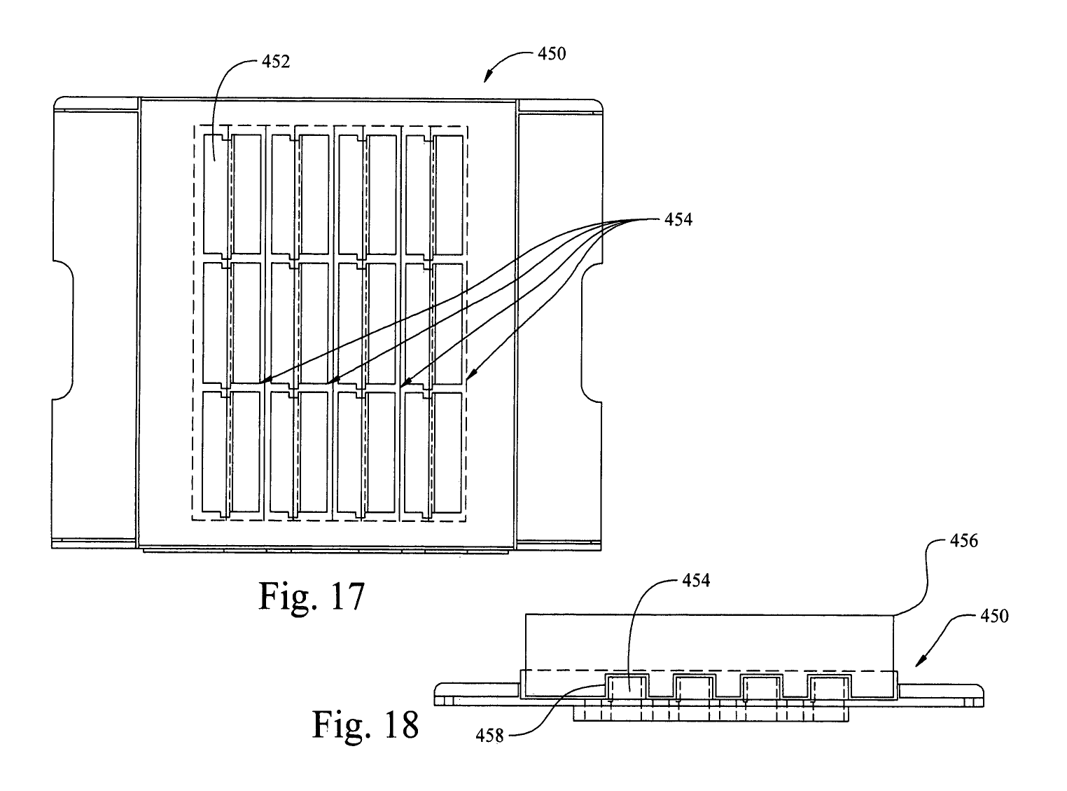

FIG. 17 shows a top perspective view of a mold box 450 that is used to form the straight block 30. The mold box 450 is generally rectangular in shape and has twelve mold cavities 452 which has the capacity to form twelve straight blocks 30 at a time. Although twelve mold cavities 452 are shown, it is possible to have more or less mold cavities 452 in the mold box 450. Each of the mold cavities 452 has an elevated portion 454 which is used to form the right elevated side face 44, the left elevated side face 50, and the elevated top portion 36 of the block 30. As can appreciated, other mold boxes 450 may be constructed to form the various other blocks 100, 150, 200, 250, 300, and 350 which have been described above in detail.

With reference to FIG. 18, the mold box 450 is illustrated having a strike-off plate 456 which is configured to remove any excess concrete mixture which is used to form the blocks 30. The plate 456 has cut out areas 458 which allow the plate 456 to move over each elevated portion 454 of the mold 450. In this manner, excess concrete mixture is removed from both the elevated top portion 36 and the lower top portion 38 when forming the block 30 in the mold 450.

As can be appreciated, the blocks 30, 100, 150, 200, 250, 300, and 350 of the present disclosure are formed in the mold box 450. Generally, the process entails molding the blocks 30, 100, 150, 200, 250, 300, and 350 by using a mixture of cement, rock, sand, and water and other materials. Once the mixture is inserted into each of the mold cavities 452 of the mold box 450, the screed or strike-off plate 456 is passed over the mold box 450 and the elevated portions 454 to remove any excess mixture. The blocks 30, 100, 150, 200, 250, 300, and 350 are fabricated by compressing and vibrating the mixture in the mold box 450 by the application of pressure to the mixture by use of a block machine or similar machine. It is also known to use a press head having a press plate for applying pressure to the mold box 450. The press plate may have a pattern, such as a stone pattern, to add character to the visible surfaces of the blocks 30, 100, 150, 200, 250, 300, and 350. By way of example only, the elevated top portion 36 and the lower top portion 38 of the block 30 are visible surfaces which may have a pattern formed therein. For example, the press plate may have a cobblestone pattern that may be transferred to the visible surfaces 36 and 38 of the block 30. Also, the press plate may be heated to facilitate release of the press plate from the block 30. Once the blocks 30, 100, 150, 200, 250, 300, and 350 are formed they may be cured through any method known in the art. For example, curing may take the form of air curing for a number of days or steam curing, but normally one day is allowed or needed for cure.

Many combinations of concrete mixtures may be employed in manufacturing the blocks 30, 100, 150, 200, 250, 300, and 350. Some considerations in determining the particular concrete mixtures include compression strength requirements, density, and adsorption. Further, the costs of the materials, such as sand, gravel, cement, pigment additives, and rock have an impact on the mixture to be used. For example, gravel may be cheaper than river rock in some areas of the country and the blocks 30, 100, 150, 200, 250, 300, and 350 may be formed of a mixture having more gravel than rock due to the difference in cost. The blocks 30, 100, 150, 200, 250, 300, and 350 may be constructed with colored pigments to form different colored blocks. In particular and by way of example only, the block 30 may be formed from one color, the block 100 may be constructed of a second or different color, and the block 300 may be constructed of a third color. In this manner the blocks 30, 100, and 300 may have contrasting colors that add to texture, appearance, or detail of the landscape edging system 10. It should be recognized that the blocks 30, 100, 150, 200, 250, 300, and 350 of the present disclosure may be constructed of various materials that are available. Preferably, the blocks 30, 100, 150, 200, 250, 300, and 350 will be of relatively lightweight so that the blocks 30, 100, 150, 200, 250, 300, and 350 can be easily manufactured, stored, transported, and installed.

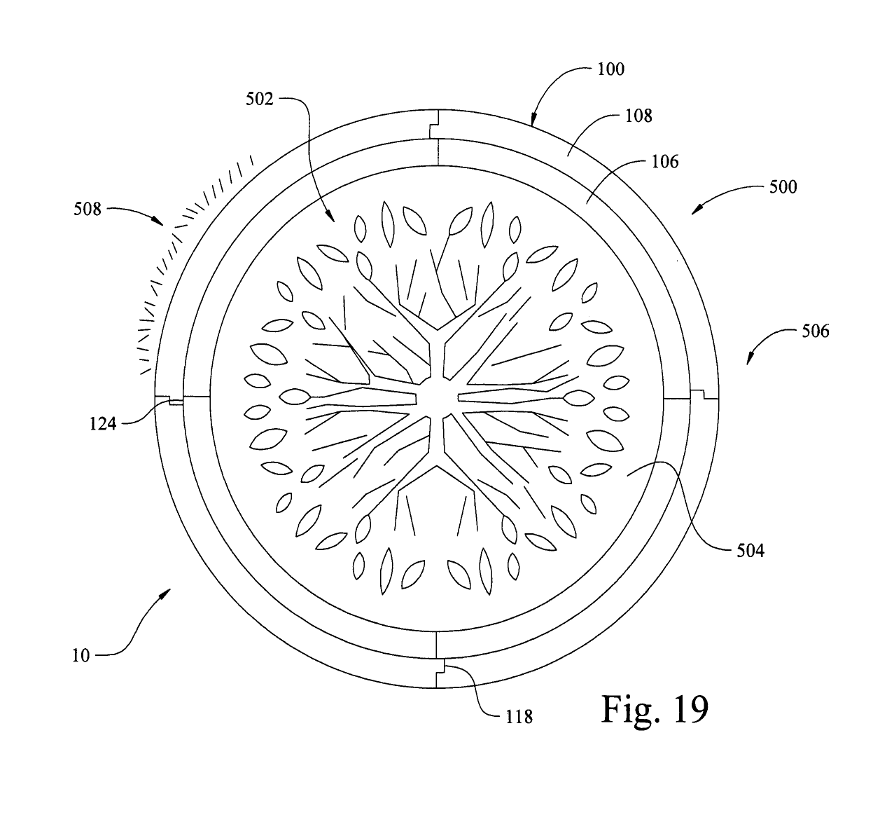

FIG. 19 shows the landscape edging system 10 constructed as a tree ring 500 constructed using blocks 100 to border a tree 502. In particular, since each of the blocks 100 has a 90° radius only four of the blocks 100 are required to form a circular border around the tree 502. The tree 502 is positioned in an elevated area 504 which is above a ground area 506 having grass 508. The blocks 100 are connected together by use of the groove portion 118 and the tongue portion 124. Each of the blocks 100 has the elevated top portion 106 and the lower top portion 108. The lower top portion 108 presents a platform or surface upon which wheels of lawn cutting equipment may ride or travel upon when cutting the grass 508. As can be appreciated, the grass 508 that grows along or adjacent to the blocks 100 is cut to the same height as the grass 508 that grows in the ground area 506. The blocks 100 also keep or hold in any mulch, dirt, or rocks in the elevated area 504. The blocks 100 extend along the entire elevated area being bordered by the landscape edging system 10. Although not shown, it is also possible and contemplated to use the blocks 300 to construct the tree ring 500. In this case, sixteen of the blocks 300 may be used to form a complete circle around the elevated area 504. Further, other blocks, such as the blocks 30, 150, 200, 250, and 350 may be used to construct a border having any configuration around the tree 502 and the elevated area 504. For example, a combination of blocks 30 and 200 may be used to construct a rectangular border around the tree 502 and the elevated area 504.

As can be appreciated, the landscape edging system 10 of the present disclosure may be used for both commercial and residential use in building various borders for a landscaped area. Numerous other designs or shapes for various borders for a landscaped area may be formed by using the blocks 30, 100, 150, 200, 250, 300, and 350. Further, instructions for a particular border may be provided with the blocks 30, 100, 150, 200, 250, 300, and 350 to assist in installation of the particular border. By using the instructions, an individual or homeowner will be able to construct a border quickly and easily.

Other advantages associated with the use of the landscape edging system 10 include the reduced number of different components or parts that need to be manufactured, transported, stored, or inventoried. Since only two separate mold boxes need to be constructed to manufacture the blocks 30 and 200 to construct a square shaped border, manufacturing costs are significantly reduced. In particular, only having two molds can greatly reduce manufacturing costs. Further, with use of the blocks 30, 300, and 350 nearly all shapes and patterns can be installed. The landscape edging system 10 is also easy to install or build with and various different shaped borders being capable of being constructed or installed. Other examples of borders that may be constructed using the landscape edging system 10 of the present disclosure include borders around paths, sidewalks, floors, patios, steps, streets, and driveways.

From all that has been said, it will be clear that there has thus been shown and described herein a landscape edging system which fulfills the various advantages sought therefore. It will become apparent to those skilled in the art, however, that many changes, modifications, variations, and other uses and applications of the subject landscape edging system are possible and contemplated. All changes, modifications, variations, and other uses and applications which do not depart from the spirit and scope of the disclosure are deemed to be covered by the disclosure, which is limited only by the claims which follow.

1. A landscape edging system comprising a plurality of blocks for forming an edging with one of the blocks comprising a back face that is configured to be placed against a raised area, a bottom face for placement on the ground, an elevated top portion, a lower top portion, an elevated front face between the elevated top portion and the lower top portion, a lower side front face, a right elevated side face, a right lower side face having a tongue portion positioned on the right lower side face extending out from the right lower side face and the lower top portion and the bottom face and extending from the lower top portion to the bottom face, a left elevated side face, a left lower side face having a groove portion positioned on the left lower side face and extending into the left lower side face, the bottom face, and the lower top portion.

2. The landscape edging system of claim 1 wherein one of the plurality of blocks is a straight block.

3. The landscape edging system of claim 1 wherein one of the plurality of blocks is an arcuate block.

4. The landscape edging system of claim 3 wherein the arcuate block has an angle of curvature of 90°.

5. The landscape edging system of claim 3 wherein the arcuate block has an angle of curvature of 22.5°.

6. The landscape edging system of claim 1 wherein one of the plurality of blocks is an inside corner block.

7. The landscape edging system of claim 1 wherein one of the plurality of blocks is an outside corner block.

8. The landscape edging system of claim 1 wherein one of the plurality of blocks is an inside radius block.

9. A landscape edging system for forming a border surface along a multilevel landscape setting having a lawn area and a raised area, the lawn area having a ground surface having grass that is mowed and the raised area having a surface that is elevated above the ground surface of the lawn area, the landscape edging system comprising a plurality of blocks for forming the border with one of the blocks comprising a back face that is configured to be placed against the raised area, a bottom face for placement in the ground, an elevated top portion, a lower top portion, an elevated front face between the elevated top portion and the lower top portion, a lower side front face, a right elevated side face, a right lower side face having a tongue portion positioned on the right lower side face extending out from the right lower side face and the lower top portion and the bottom face and extending from the lower top portion to the bottom face, a left elevated side face, and a left lower side face having a groove portion positioned on the left lower side face and extending into the left lower side face, the lower top portion, and the bottom face.

10. The landscape edging system of claim 9 wherein one of the tongue portions of one of the blocks fits within one of the groove portions of another one of the blocks.

11. The landscape edging system of claim 9 wherein each of the tongue portions has rounded edges and each of the groove portions has rounded edges.

12. The landscape edging system of claim 9 wherein one of the plurality of blocks is a straight block.

13. The landscape edging system of claim 9 wherein one of the plurality of blocks is an arcuate block.

14. The landscape edging system of claim 13 wherein the arcuate block has an angle of curvature of 90°.

15. A landscape edging system for forming a border surface along a multilevel landscape setting having a lawn area and a raised area, the lawn area having a ground surface having grass that is mowed and the raised area having a surface that is elevated above the ground surface of the lawn area, the landscape edging system comprising a plurality of blocks for forming the border with each of the blocks comprising a back face that is configured to be placed against the raised area, a bottom face for placement in the ground, an elevated top portion, a lower top portion, an elevated front face between the elevated top portion and the lower top portion, a lower side front face, a right elevated side face, a right lower side face having a tongue portion positioned on the right lower side face extending out from the right lower side face and the lower top portion and the bottom face and extending from the lower top portion to the bottom face and between the lower side front face and the right lower side face, a left elevated side face, and a left lower side face having a groove portion positioned on the left lower side face and extending into the left lower side face, the lower top portion, and the bottom face and between the lower side front face and the left lower side face.

16. The landscape edging system of claim 15 wherein one of the plurality of blocks is a straight block.

17. The landscape edging system of claim 15 wherein one of the plurality of blocks is an arcuate block.

18. The landscape edging system of claim 17 wherein the arcuate block has an angle of curvature of 90°.

19. The landscape edging system of claim 17 wherein the arcuate block has an angle of curvature of 22.5°.

20. The landscape edging system of claim 15 wherein one of the tongue portions of one of the blocks fits within one of the groove portions of another one of the blocks.
